(19) United States
(12) Patent Application Publication
(10) Pub. No.: US 2009/0084351 A1
(43) Pub. Date: Apr. 2, 2009

(54) IDLE SPEED CONTROL METHOD FOR CONTROLLING THE IDLE SPEED OF AN ENGINE WITH A CONTINUOUS VARIABLE EVENT AND LIFT SYSTEM AND A FUEL CONTROL SYSTEM USING THE METHOD

(75) Inventor: Seiji ASANO, Hitachinaka (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/242,115

(22) Filed: Sep. 30, 2008

(30) Foreign Application Priority Data
Oct. 1, 2007 (JP) 2007-257034

(51) Int. Cl. F02D 41/00

(52) U.S. Cl. 123/339.14; 701/103

(57) ABSTRACT

Air quantity of ISC is roughly controlled on the basis of the lift amount of an intake valve, whose air flow rate control range is wide. The adjustment of the air quantity beyond the range of the rough control is achieved by the control based on a phase of the intake valve. As a result, a required flow rate can be achieved with high accuracy. If only the intake-valve lift amount whose air flow rate control range is wide is used to achieve the required air quantity of ISC, a fuel control system requires both a high degree of accuracy of an intake-valve lift amount sensor and a high degree of accuracy of an intake-valve lift amount control mechanism itself, which leads to high system costs.

The air quantity of ISC is roughly controlled on the basis of the intake-valve lift amount whose air flow rate control range is wide (the air quantity is controlled based on an air flow rate corresponding to each integral multiple of the air flow rate control minimum resolution). The adjustment of the air quantity beyond the range of the rough control is achieved by the control based on a phase of the intake valve. The intake-valve phase-based control makes it possible to control the air quantity within a range of about 0.4 to 1.2 times the typical air quantity at this point of time. The air quantity, therefore, can be accurately controlled so that the air quantity is kept at a target air flow rate. Accordingly, the target revolution speed of ISC can be stably achieved.

### BACKGROUND OF THE INVENTION

1. Field of the Invention

The present invention particularly relates to an idle speed control method used for an engine in which a continuous variable event and lift system controls the amount of intake air.

2. Description of the Related Art

Heretofore, a deviation of the engine speed from the target revolution speed of ISC as well as factors relating to a lift state (lift action angle) changed by a lift-amount changing mechanism of an intake valve are reflected in feedback terms for controlling the amount of intake air (See JP-A-2006-63885).

### SUMMARY OF THE INVENTION

A problem to be solved by the present invention lies in the control accuracy in the lift state. The feedback terms for controlling the amount of intake air are reflected in the target air quantity required, and are then replaced with the opening angle of a throttle and the lift amount of an intake valve. If the target air quantity requires the higher accuracy than that of the throttle opening angle, or that of the minimum resolution of the amount of intake air achieved by an intake valve lift, the air quantity whose value is around the target air quantity will cause vibrations. A system free from vibrations requires a high degree of control accuracy of both the throttle opening control unit and the intake-valve lift amount control unit, and also requires an improvement in accuracy of a detection unit of a position sensor. Therefore, it is necessary to improve the assembling accuracy of a mechanism and the accuracy of the mechanism itself. This leads to an increase in system costs.

The target air quantity is roughly achieved by the opening angle of the throttle or the lift amount of the intake valve. After the air quantity is roughly achieved, the air quantity is adjusted by a phase angle of the intake valve. Incidentally, if the adjustment exceeds a control range of the phase angle of the intake valve, the rough air quantity is changed for each control resolution of the throttle opening angle or that of the intake-valve lift amount, and the air quantity is then adjusted by the phase of the intake valve again.

The opening angle of the throttle or the lift amount of the intake valve is roughly controlled. The adjustment of the air quantity beyond the range of the rough control is achieved by the control based on a phase of the intake valve. As a result, the target air quantity of ISC can be accurately controlled as required, and accordingly the revolution speed of the engine can be controlled such that the revolution speed is stably kept at the target revolution speed of ISC.

Furthermore, because the fuel control system according to the present invention does not require, at high levels, the accuracy of the position sensor, the assembling accuracy of the mechanism, and the accuracy of the mechanism itself, system costs can be suppressed.

According to one aspect of the present invention, an engine fuel control system comprises: means for acquiring the revolution speed of an engine; means for controlling the opening angle of an intake valve; means for controlling a phase of the intake valve; means for detecting an idle state of the engine; means for setting the target revolution speed at the time of idling; means for acquiring a plurality of control variables that enable the engine to operate at the target revolution speed when the idle state is detected; means for assigning a control variable whose amount of change is large to the control of the opening angle of the intake valve, said control variable being selected from among the plurality of control variables; and means for assigning a control variable whose amount of change is small to the control of a phase of the intake valve, said control variable being selected from among the plurality of control variables.

### BRIEF DESCRIPTION OF THE DRAWINGS

FIG. 1 is a diagram illustrating an example of a control block of a fuel control system according to the present invention;

FIG. 2 is a diagram illustrating an example of an engine and its surrounding components, all of which are controlled by a fuel control system according to the present invention;

FIG. 3 is a diagram illustrating an example of an internal configuration of a fuel control system according to the present invention;

FIG. 4 is a diagram illustrating an example of the control behavior of an intake valve achieved by a fuel control system according to the present invention;

FIG. 5 contains charts illustrating characteristics of a continuous variable event and lift system controlled by a fuel control system according to the present invention, one illustrating as an example the relationship between the opening angle of the intake valve and the amount of intake air, and the other illustrating as an example the relationship between a phase of the intake valve and a filling factor;

FIG. 6 is a block diagram illustrating an example of an idle speed control method for controlling the idle speed of an engine equipped with a variable valve by a fuel control system according to the present invention;

FIG. 7 is a block diagram illustrating another example of an idle speed control method for controlling the idle speed of an engine equipped with a variable valve by a fuel control system according to the present invention;

FIG. 8 is a block diagram illustrating an example of feedback P-portion arithmetic operation included in feedback-value arithmetic operation shown in FIGS. 6 and 7 controlled by a fuel control system according to the present invention;

FIG. 9 is a block diagram illustrating an example of feedback I-portion arithmetic operation included in the feedback-value arithmetic operation shown in FIG. 7 controlled by a fuel control system according to the present invention;

FIG. 10 is a block diagram illustrating an example of how to calculate a target flow rate correction value for the phase control amount arithmetic operation shown in FIGS. 6 and 7 controlled by a fuel control system according to the present invention;

FIG. 11 is a block diagram illustrating an example of how to calculate a phase learning value for the phase control amount arithmetic operation shown in FIGS. 6 and 7 controlled by a fuel control system according to the present invention;

FIG. 12 contains charts each illustrating as an example the control behavior of an idle speed control method for controlling the idle speed of an engine equipped with a variable valve by a fuel control system according to the present invention;

FIG. 13 is a flowchart illustrating in detail an example of the control by a fuel control system according to the present invention;

FIG. 14 is a flowchart illustrating in detail an example of an idle speed control method for controlling an idle speed in FIG. 6 by a fuel control system according to the present invention;

FIG. 15 is a flowchart illustrating in detail another example of an idle speed control method for controlling an idle speed in FIG. 6 by a fuel control system according to the present invention;

FIG. 16 is a flowchart illustrating an example of how to calculate the feedback P portion in FIGS. 6 and 7 by a fuel control system according to the present invention;

FIG. 17 is a flowchart illustrating an example of how to calculate the feedback I portion in FIG. 7 by a fuel control system according to the present invention;

FIG. 18 is a flowchart illustrating an example of target flow rate correction processing included in the phase control amount arithmetic operation in FIGS. 6 and 7 performed by a fuel control system according to the present invention; and

FIG. 19 is a flowchart illustrating an example of how to calculate a phase learning value in the phase control amount arithmetic operation in FIGS. 6 and 7 performed by a fuel control system according to the present invention.

### DESCRIPTION OF THE PREFERRED EMBODIMENTS

Embodiments of the present invention will be described below with reference to the accompanying drawings.

### First Embodiment

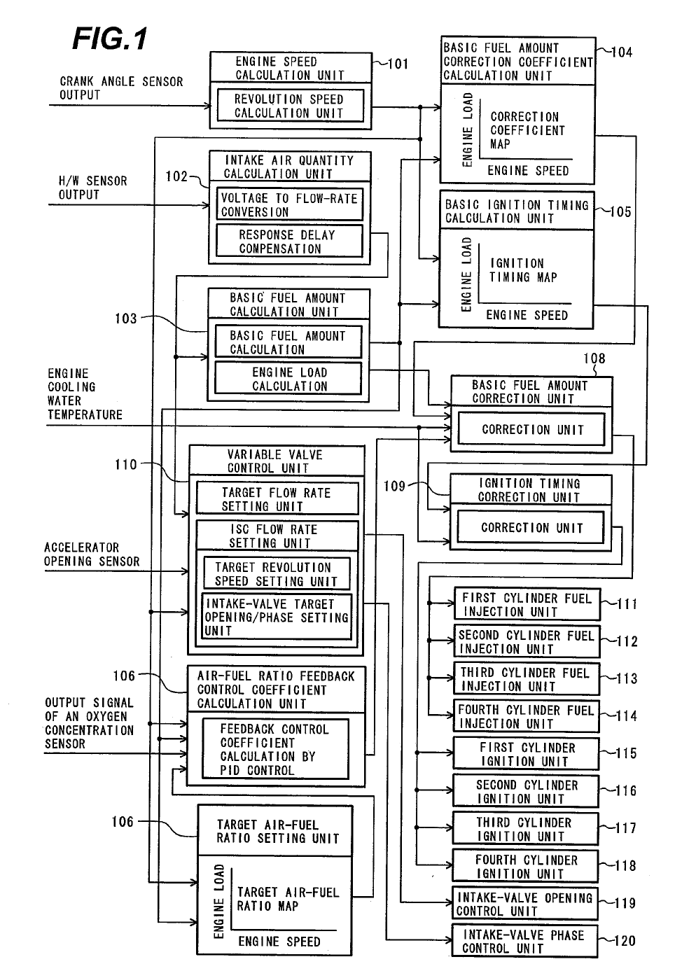

Main embodiments of the present invention will be described below with reference to the accompanying drawings. FIG. 1 is a diagram illustrating an example of a control block of a fuel control system having a control method for controlling the idle speed of an engine equipped with a variable valve according to the present invention. Block 101 is a block of an engine speed calculation unit. The revolution speed of an engine per unit time is calculated by counting electrical signals of a crank angle sensor set at a specified angle in the engine (mainly, the number of inputs of changes in pulse signal per unit time) and then by performing arithmetic processing of the count. In Block 102, a hot-wire (hereinafter referred to as “H/W”) sensor signal is subjected to voltage-to-flow-rate conversion to determine the intake air amount of the engine; for the determined intake air amount, delays at the time of measuring the intake air amount and at the time of the intake air flowing into a cylinder are corrected. The correction of the delays is, for example, first-order lag compensation for the arrival time of airflow (detailed description thereof is omitted here). In Block 103, the basic fuel amount required by the engine in each area, and an engine load index, are calculated on the basis of the revolution speed of the engine calculated in Block 101 and the quantity of air taken in by the engine. In Block 104, a correction coefficient of the basic fuel amount in each operation area of the engine is calculated on the basis of the revolution speed of the engine calculated in Block 101 and the above-described engine load. As described above, the basic fuel amount in each operation area of the engine has been calculated in Block 103. Block 105 is a block in which the optimum ignition timing in each operation area of the engine is determined by a map search, or the like, on the basis of the engine speed and engine load described above. In Block 106, from the output of an oxygen concentration sensor provided in an exhaust pipe of the engine, an air-fuel ratio feedback control coefficient is calculated such that a mixture gas of air and fuel supplied to the engine is kept at a target air-fuel ratio described below. Incidentally, in this embodiment, the above-described oxygen concentration sensor outputs a signal that is proportional to an exhaust air-fuel ratio. However, it is also possible to adopt such an oxygen concentration sensor that outputs two signals of an exhaust gas (more specifically, a signal on the rich side and a signal on the lean side with respect to a theoretical air-fuel ratio).

In Block 107, an optimum target air-fuel ratio in each area of the engine is determined by a map search, or the like, on the basis of the engine speed and engine load described above. The target air-fuel ratio determined in this block is used for the air-fuel ratio feedback control of Block 106.

In Block 108, the basic fuel amount calculated in Block 103 is corrected on the basis of the basic fuel amount correction coefficient calculated in Block 104, the air-fuel ratio feedback control coefficient calculated in Block 106, and the like.

In Block 109, the ignition timing, which has been acquired by the map search in Block 105, is corrected on the basis of cooling water temperature of the engine, or the like.

In Block 110, the amount of intake air required by the engine is set in response to a signal of an accelerator opening sensor to determine the opening angle of an intake valve; the target revolution speed and target airflow at the time of idling are set so as to keep the idling revolution speed of the engine constant; and the opening angle and phase of the intake valve are calculated.

Blocks 111 through 114 are fuel injection units, each of which supplies the engine with fuel whose amount has been calculated in Block 108. Blocks 115 through 118 are ignition units, each of which ignites a fuel-air mixture gas flowed into the cylinder in response to the ignition timing required by the engine. The ignition timing has been corrected in Block 109 as described above.

Block 119 is an intake-valve opening control unit for controlling the opening angle of the intake valve at the time of idling, which has been calculated in Block 110. Block 120 is an intake-valve phase control unit for controlling the phase of the intake valve at the time of idling, which has been calculated in Block 110.

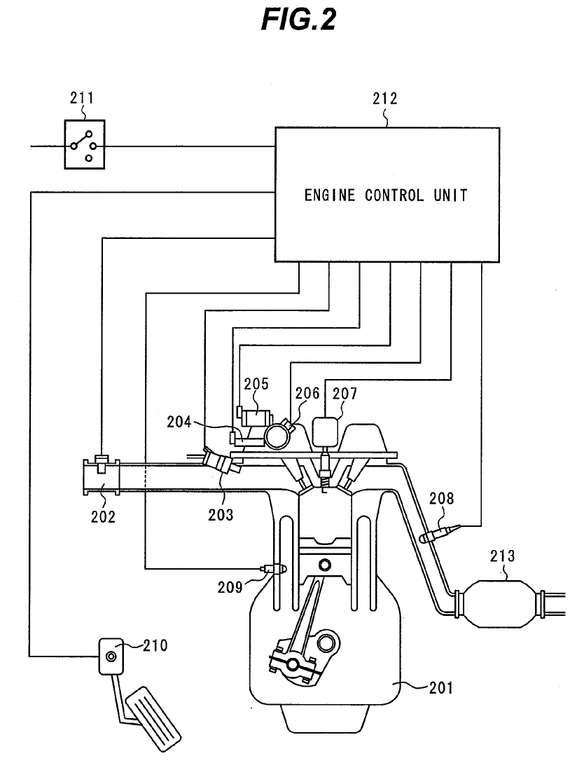

FIG. 2 is a diagram illustrating as an example an engine and its surrounding components, all of which are controlled by a fuel control system having an idle speed control method for controlling the idle speed of the engine equipped with a variable valve according to the present invention. An engine 201 includes: an H/W sensor 202 for measuring the quantity of air taken in by the engine; a fuel injection valve 203 for supplying fuel required by the engine; a crank angle sensor 206 for outputting a signal at each specified crank angle of the engine, and for outputting a phase signal between opening and shutting of the intake valve; a hydraulic valve 204 for controlling a phase of the intake valve; an electric motor 205 that controls the opening angle of the intake valve, and that includes a built-in intake-valve opening sensor for detecting the opening angle of the intake valve; an ignition module 207 for supplying a spark plug with ignition energy on the basis of an ignition signal of an engine control unit 212 so as to cause the spark plug to ignite a mixture gas of the fuel fed into the cylinder of the engine; an oxygen concentration sensor 208 for detecting the concentration of oxygen contained in an exhaust gas, the oxygen concentration sensor 208 being mounted to an exhaust pipe of the engine; a cooling water temperature sensor 209 for detecting the circulating water temperature of the engine, the cooling water temperature sensor 209 being disposed in a cylinder block of the engine; a three-way catalyst 213 disposed at a position behind the oxygen concentration sensor of the exhaust pipe; an accelerator opening sensor 210 for detecting the accelerator opening angle; an ignition key switch 211 that is a main switch used to start/stop the engine; and an engine control unit 212 for controlling each related component of the engine.

Incidentally although the opening angle and phase of the intake valve are controlled by the electric motor 205 and the hydraulic valve 204 in this embodiment, the intake valve itself may also be driven as a magnetic valve.

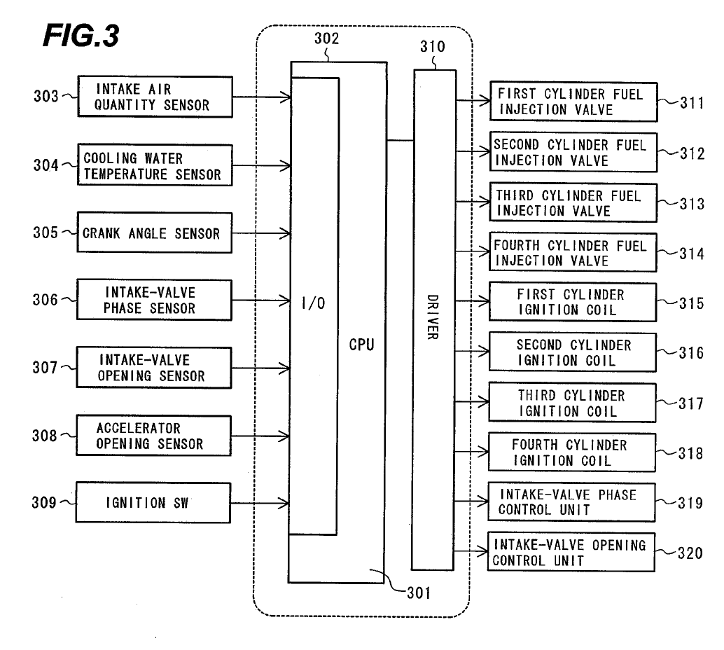

FIG. 3 is a diagram illustrating as an example an internal configuration of a fuel control system having an idle speed control method for controlling the idle speed of an engine equipped with a variable valve according to the present invention.

A CPU 301 includes an I/O unit 302 for converting an electric signal of each sensor disposed in the engine into a signal used for digital arithmetic processing, and for converting a control signal used for digital arithmetic operation into a driving signal of an actual actuator. The I/O unit 302 receives input signals from an intake air quantity sensor 303, a cooling water temperature sensor 304, a crank angle sensor 305, an intake-valve phase sensor 306, an intake-valve opening sensor 307, an accelerator opening sensor 308, and an ignition SW 309. The CPU 301 transmits, through an output signal driver 310, output signals to fuel injection valves 311 through 314, ignition coils 315 through 318, an intake-valve phase control unit 319, and an intake-valve opening control unit 321.

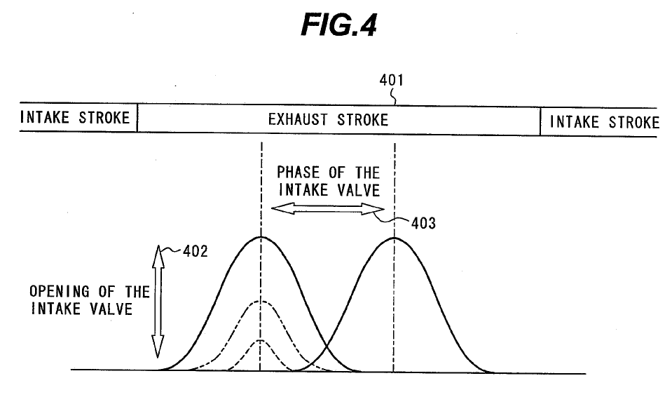

FIG. 4 is a diagram illustrating, as an example, the control behavior of an intake valve achieved by a fuel control system having an idle speed control method for controlling the idle speed of an engine equipped with a variable valve according to the present invention. During an intake stroke 401, the opening angle 402 of the intake valve and a phase 403 of the same are controlled by the hydraulic valve, the electric motor, a magnetic valve, or the like.

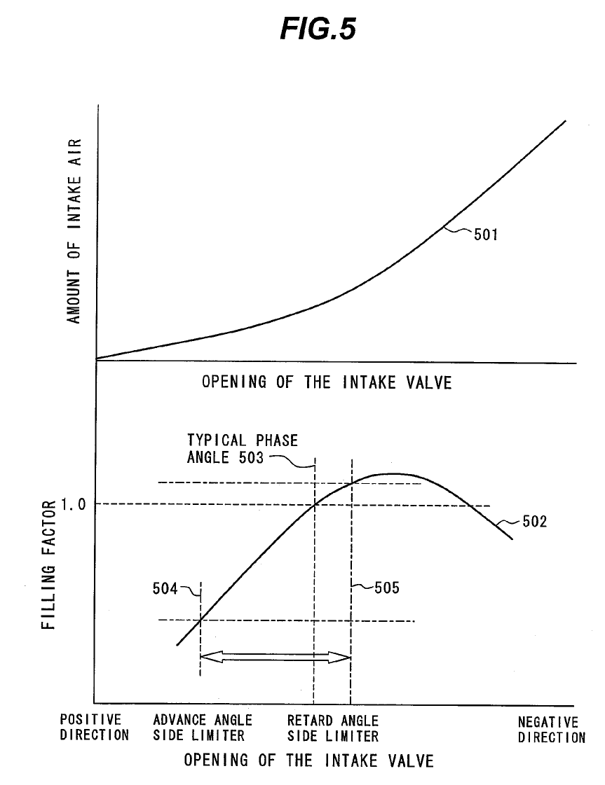

FIG. 5 contains charts illustrating characteristics of a variable valve of an engine according to this embodiment, one illustrating as an example the relationship between the opening angle of the intake valve and the amount of intake air, and the other illustrating as an example the relationship between a phase of the intake valve and a filling factor. A line 501 expresses the relationship between the opening angle of the intake valve and the amount of intake air. A line 502 expresses the relationship between a phase of the intake valve and a filling factor. The filling factor is expressed on the assumption that the amount of intake air at a typical phase angle 503 is 1.0. Incidentally, the phase angle is so controlled that it falls within a range between an advance side limiter 504 and a delay side limiter 505; and the limiters are determined on the basis of the engine and the control.

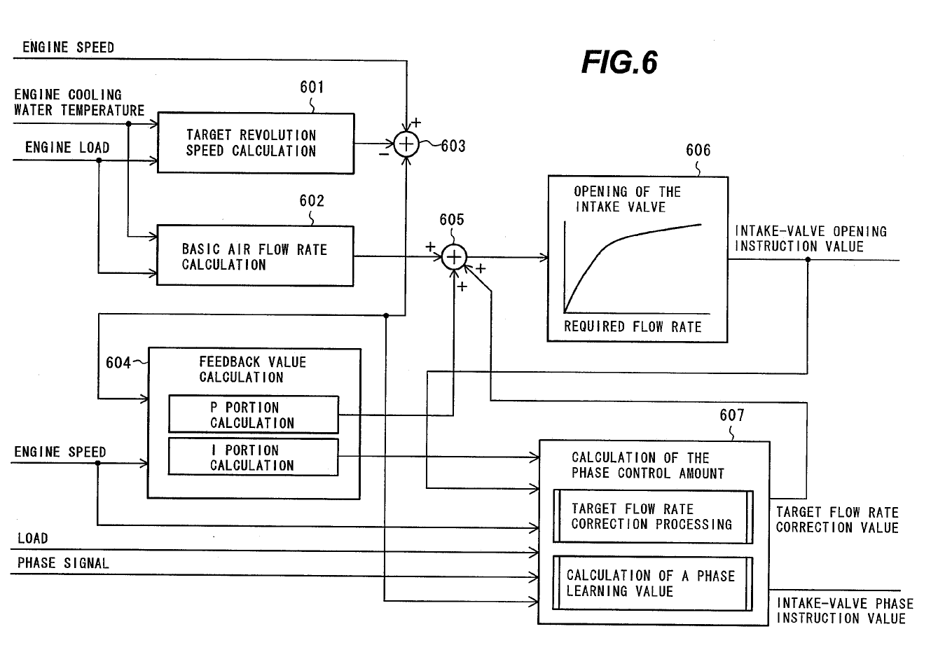

FIG. 6 is a block diagram illustrating an example of an idle speed control method for controlling the idle speed of an engine equipped with a variable valve according to this embodiment. Block 601 determines the target revolution speed at the time of idling on the basis of the cooling water temperature of the engine and the engine load. Block 602 determines a basic air flow rate required at the time of idling on the basis of the cooling water temperature and the engine load. A difference unit 603 calculates the difference between the target revolution speed determined in Block 601 and the current revolution speed of the engine. Block 604 calculates, on the basis of the difference in revolution speed, P (Proportional) and I (Integral) portions of feedback to keep the engine speed at its target value. Block 607 calculates an intake-valve phase command value and a target flow rate correction value on the basis of the feedback I portion, an intake-valve opening angle command value, the engine speed, a load, an intake-valve phase signal, and a value of the difference in revolution speed. Incidentally, Block 607 is configured to learn a calculated phase value. An adder 605 adds up the basic flow rate, the feedback P portion, and the target flow rate correction value to calculate a required flow rate. Block 606 makes a table search for the opening angle of the intake valve from the required flow rate. The opening angle of the intake valve is used as the intake-valve opening angle command value.

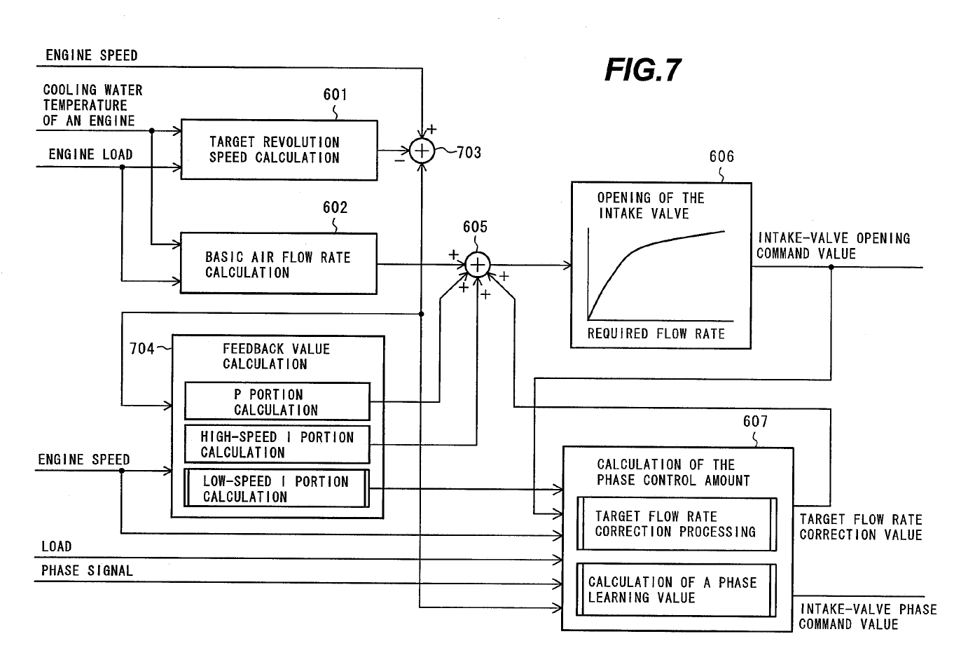

FIG. 7 is a block diagram illustrating another example of an idle speed control method for controlling the idle speed of an engine equipped with a variable valve according to this embodiment. A point of difference between this example and the above-described example shown in FIG. 6 is that as the arithmetic operation of a feedback value in Block 704, the arithmetic operation of the feedback I portion is divided into a high-speed I portion and a low-speed I portion.

Incidentally, in the examples shown in FIGS. 6, 7, the intake-valve opening angle command value is the lift amount of the intake valve. However, in the case of a system equipped with a controllable throttle valve, all or part of the intake-valve opening angle command value may also be complemented by controlling the throttle opening angle.

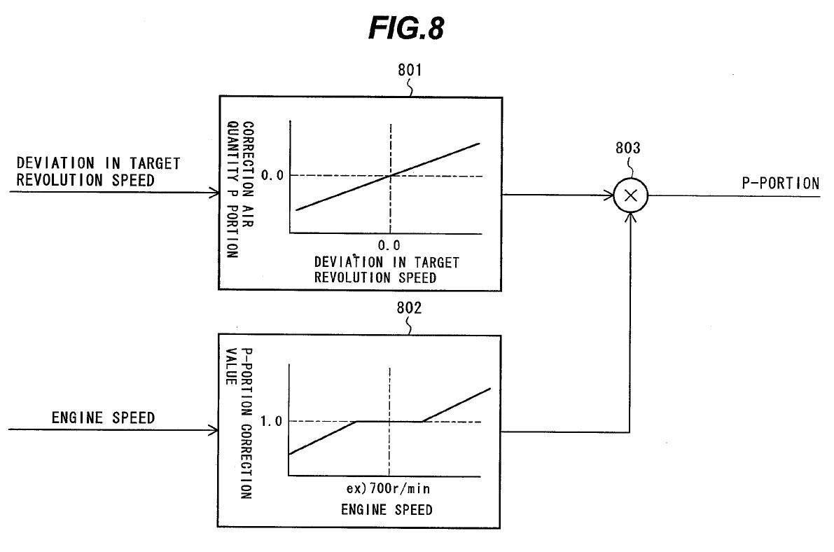

FIG. 8 is a block diagram illustrating an example of the feedback P-portion arithmetic operation included in the feedback-value arithmetic operation shown in FIGS. 6, 7. Block 801 makes a table search for a base value of a feedback P portion on the basis of a deviation in revolution speed. Block 802 makes a table search for a P-portion correction value on the basis of the engine speed. A multiplier 803 multiplies the base value of the feedback P portion by the correction value to determine the feedback P portion.

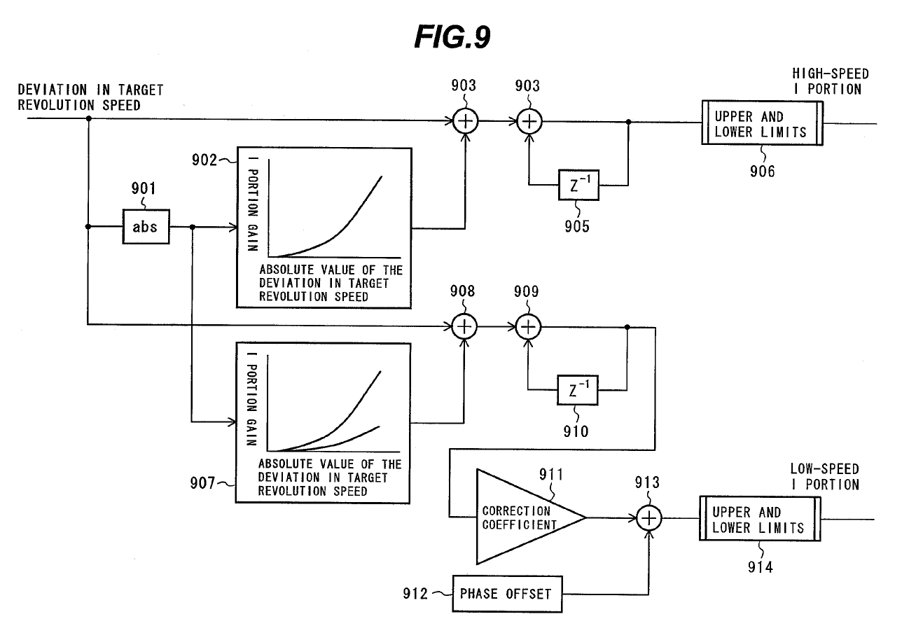

FIG. 9 is a block diagram illustrating an example of the feedback I-portion arithmetic operation included in the feedback-value arithmetic operation shown in FIG. 7. Block 901 calculates an absolute value of the deviation in revolution speed. Block 902 calculates a gain of the high-speed I portion on the basis of an absolute value of the deviation in revolution speed. A multiplier 903 multiplies the deviation in revolution speed by the gain of the high-speed I portion. The multiplied value is integrated by an adder 904 and a delay unit 905 to determine the high-speed I portion. Block 906 puts upper and lower limits on the high-speed I portion. Block 901 calculates an absolute value of the deviation in revolution speed. Block 907 calculates a gain of the low-speed I portion on the basis of the absolute value of the deviation in revolution speed. A multiplier 908 multiplies the deviation in revolution speed by the gain of the low-speed I portion. The multiplied value is integrated by an adder 909 and a delay unit 910 to determine the low-speed I portion. Block 911 multiplies the low-speed I portion by a correction coefficient, and an adder 913 then adds a phase offset 912 to the low-speed I portion to convert the low-speed I portion into an angle base value. After that, Block 914 puts upper and lower limits on the angle base value, before outputting the value.

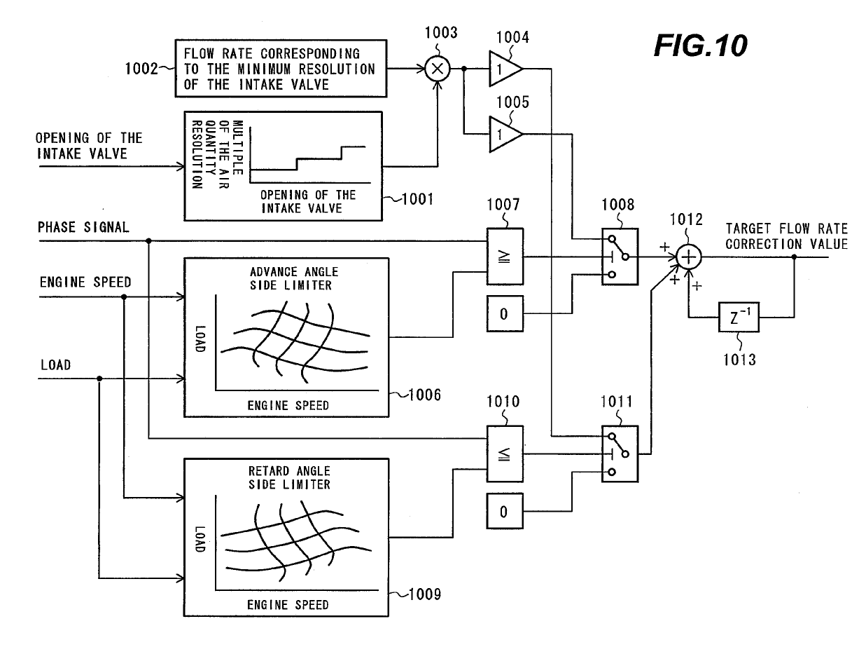

FIG. 10 is a block diagram illustrating an example of how to calculate a target flow rate correction value for the phase control amount arithmetic operation shown in FIGS. 6, 7. Block 101 makes a table search for air quantity resolution multiples from the opening angle of the intake valve. Block 1003 multiplies a flow rate 1002 corresponding to the minimum resolution of the intake valve by each of the multiples. Blocks 1004 and 1005 prepare positive and negative values for each multiplied flow rate corresponding to the minimum resolution. Block 1006 makes a map search for an advance angle side limiter of a phase on the basis of the engine speed and an engine load. A comparator 1007 judges whether or not a phase signal is larger than or equal to the advance angle side limiter. If it is judged that the phase signal is larger than or equal to the advance angle side limiter, a switch 1008 selects a flow rate corresponding to the minimum resolution on the minus side. In contrast, if it is judged that the phase signal is smaller than the advance angle side limiter, the switch 1008 selects 0. Block 1009 makes a map search for a retard angle side limiter of a phase on the basis of the engine speed and an engine load. A comparator 1010 judges whether or not a phase signal is smaller than or equal to the retard angle side limiter. If it is judged that the phase signal is smaller than or equal to the retard angle side limiter, a switch 1011 selects a flow rate corresponding to the minimum resolution on the plus side. In contrast, if it is judged that the phase signal is larger than the retard angle side limiter, the switch 1011 selects 0. The selected values are integrated by the adder 1012 and the delay unit 1013, before the acquired value is output as a target flow rate correction value.

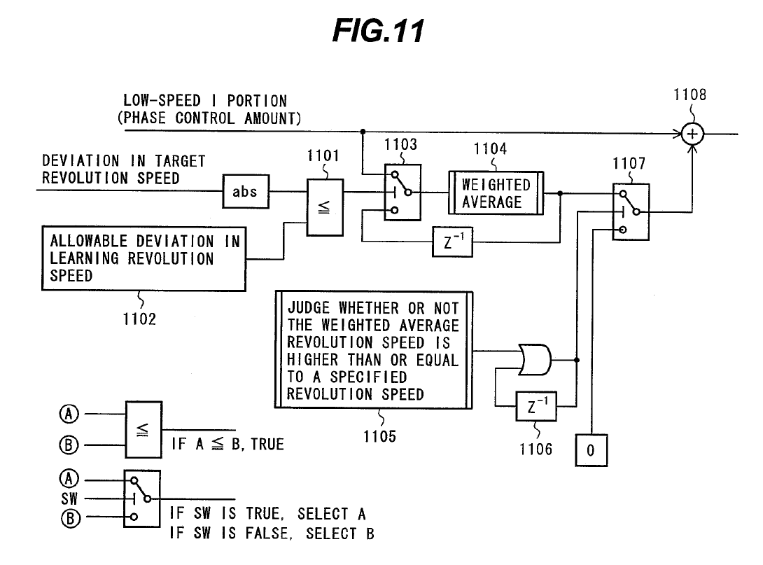

FIG. 11 is a block diagram illustrating an example of how to calculate a phase learning value for the phase control amount arithmetic operation shown in FIGS. 6 and 7. Block 101 judges whether or not an absolute value of the deviation in target revolution speed 1102 is smaller than or equal to an allowable deviation in learning revolution speed. If it is judged that the absolute value is smaller than or equal to the allowable deviation in learning revolution speed, a switch 1103 inputs the low-speed I portion into Block 1104 where weighted average revolution speed is calculated. Block 1105 judges whether or not the weighted average revolution speed is higher than or equal to a specified revolution speed. If it is judged that the weighted average revolution speed is higher than or equal to the specified revolution speed, an adder 1108 adds the weighted average value to the low-speed I portion through a switch 1107. Incidentally, the weighted average value is assigned to a storage area in which the value is kept unchanged even if an ignition SW is in an OFF state. Similarly, a value indicating that the weighted average revolution speed has been judged to be higher than or equal to the specified revolution speed is stored in the storage area by the delay unit 1106. This stored value is assigned to the same storage area as that to which the weighted average value is assigned. In addition, one example of learning is described in this embodiment. However, in general, a plurality of patterns may also be provided in response to an air conditioning load and an electrical load.

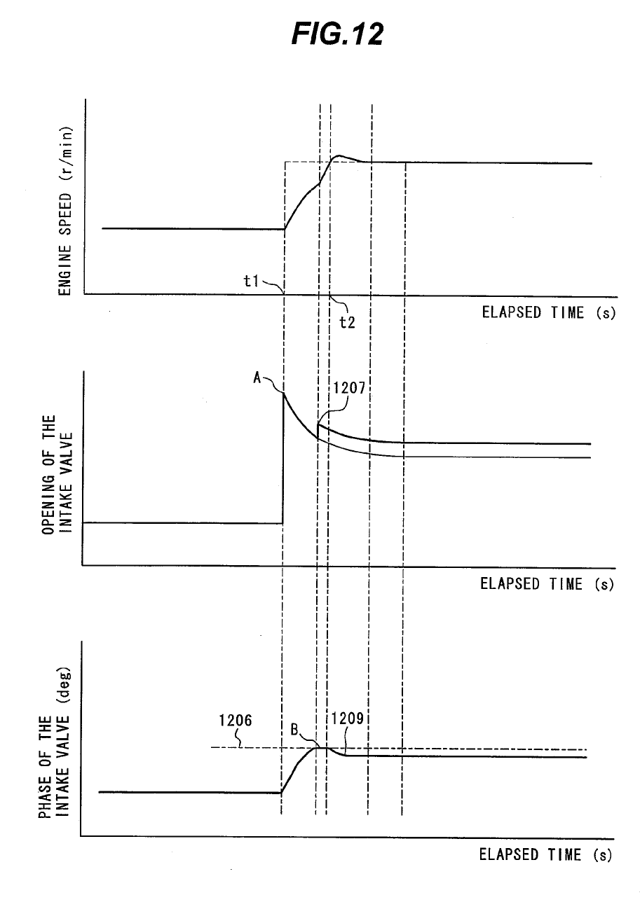

FIG. 12 contains charts each illustrating as an example the control behavior of an idle speed control method for controlling the idle speed of an engine equipped with a variable valve according to this embodiment. The upper chart shows the engine speed; the middle chart shows the opening angle of the intake valve; and the lower chart shows a phase of the intake valve. At the timing t1, because of an air conditioning load, or the like, the target revolution speed increases as indicated with a broken line. As a result of it, the opening angle of the intake valve increases up to a point A on the basis of a P portion and a high-speed I portion. A phase of the intake valve increases on the basis of a low-speed I portion, and then reaches a phase upper limit 1206a at a point B. When the phase of the intake valve reaches the phase upper limit, a target flow rate correction value 1207 is added to the opening angle of the intake valve. At the timing t2, the engine speed becomes slightly higher than the target revolution speed. As a result, the phase of the intake valve decreases.

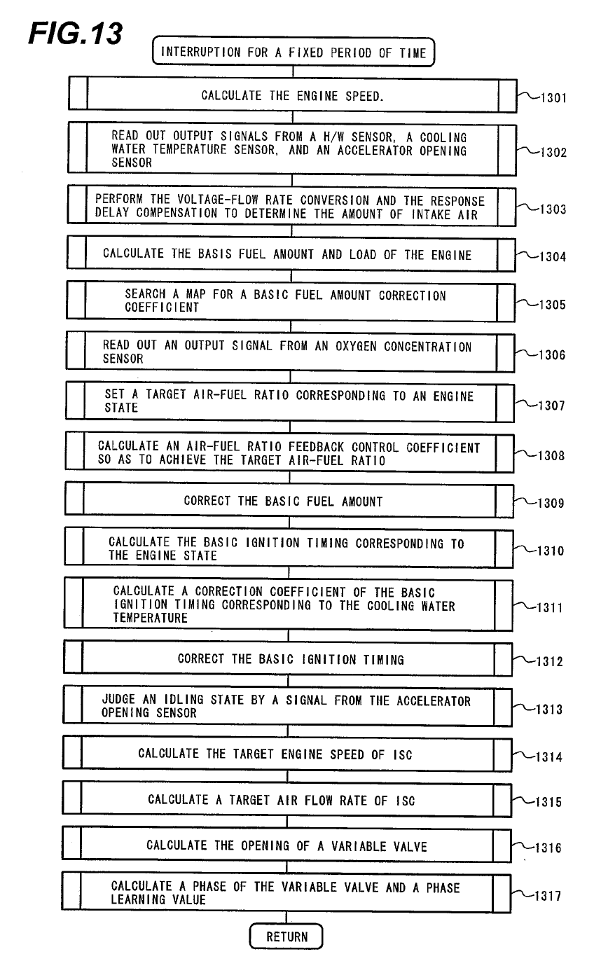

FIG. 13 is a flowchart illustrating in detail an example of the control by a fuel control system having an idle speed control method for controlling the idle speed of an engine equipped with a variable valve according to this embodiment. In Step 1301, the engine speed is read out. In Step 1302, output signals are read out from an H/W sensor, an engine cooling water temperature sensor, and an accelerator opening sensor. In Step 1303, the output signal of the H/W sensor is subjected to the voltage to flow-rate conversion and the response delay compensation so that the amount of intake air of the engine is determined. In Step 1304, the basis fuel amount and load of the engine are calculated from the engine speed and the amount of intake air. In Step 1305, from the engine speed and the engine load, a map search is made for a basic fuel amount correction coefficient. In Step 1306, an output signal is read out from an oxygen concentration sensor. In Step 1307, a target air-fuel ratio corresponding to an engine state is set. In Step 1308, an air-fuel ratio feedback control coefficient is calculated so as to achieve the target air-fuel ratio. In Step 1309, the calculated basic fuel amount is corrected by the basic fuel amount correction coefficient and the air-fuel ratio feedback control coefficient. In Step 1310, the proper basic ignition timing corresponding to a state of the engine is calculated. In Step 1311, a correction coefficient of the basic ignition timing corresponding to the engine cooling water temperature, or the like, is calculated. In Step 1312, the basic ignition timing is corrected by the correction coefficient of the basic ignition timing. In Step 1313, on the basis of a state of the accelerator opening sensor, an idling state is judged. In Step 1314, the target engine speed at the time of idling is set. In Step 1315, a target air flow rate at the time of idling is set. In Step 1316, the opening angle of a variable valve is calculated. In Step 1317, a phase of the variable valve and a phase learning value are calculated.

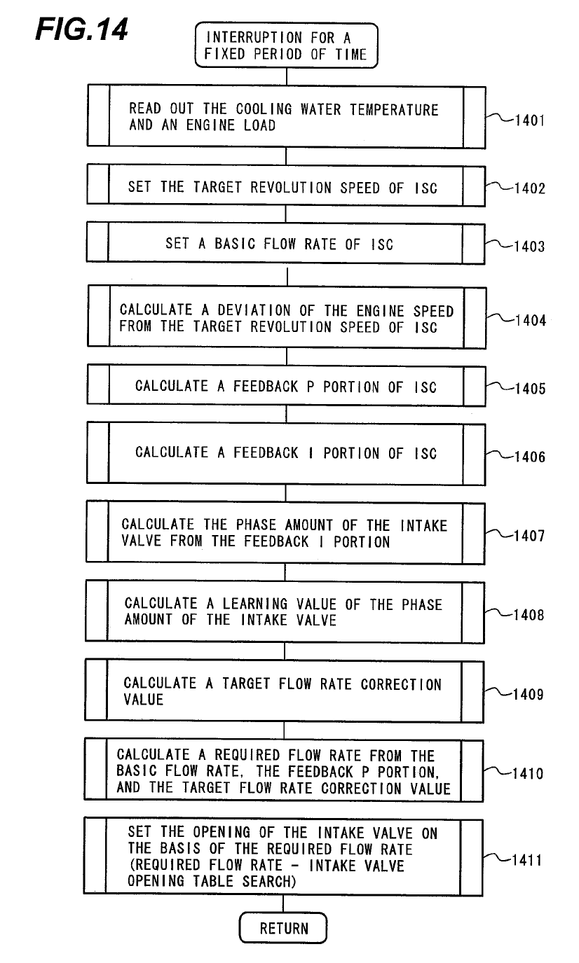

FIG. 14 is a flowchart illustrating in detail an example of an idle speed control method shown in FIG. 6. In Step 1401, the engine cooling water temperature and an engine load are read out. In Step 1402, the target engine speed at the time of idling is set. In Step 1403, a basic (target) air flow rate at the time of idling is set. In Step 1404, a deviation of the engine speed from the target engine speed is calculated. In Step 1405, a feedback P portion used to achieve the target revolution speed is calculated. In Step 1406, a feedback I portion used to achieve the target revolution speed is calculated. In Step 1407, the phase amount of the intake valve is calculated from the feedback I portion. In Step 1408, a learning value of the calculated phase amount of the intake valve is calculated. In Step 1409, a target flow rate correction value for the opening angle of the intake valve is calculated from a feedback I portion. In Step 1410, a required flow rate is calculated from the basic air flow rate, the feedback P portion, and the target flow rate correction value. In Step 1411, the opening angle of the intake valve is set on the basis of the required flow rate.

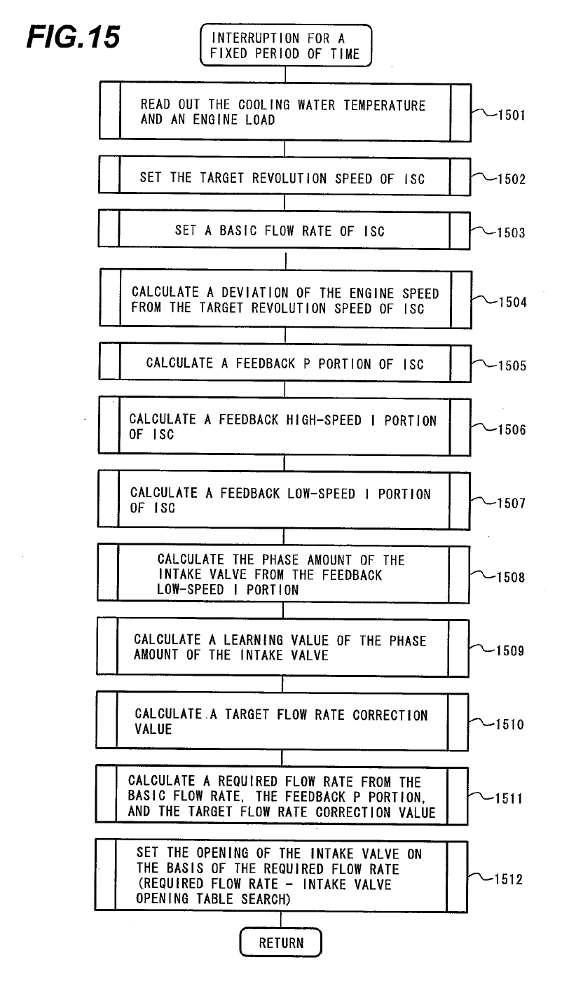

FIG. 15 is a flowchart illustrating in detail another example of an idle speed control method shown in FIG. 6. A point of difference between this example and the example shown in FIG. 14 is that although the number of feedback I portions in the example of FIG. 14 is one, the number of feedback I portions in this example of FIG. 15 is two (more specifically, a high-speed I portion and a low-speed I portion). Incidentally, it is needless to say that each of the P portion and the I portion can be divided into a plurality of portions depending on a corresponding engine configuration.

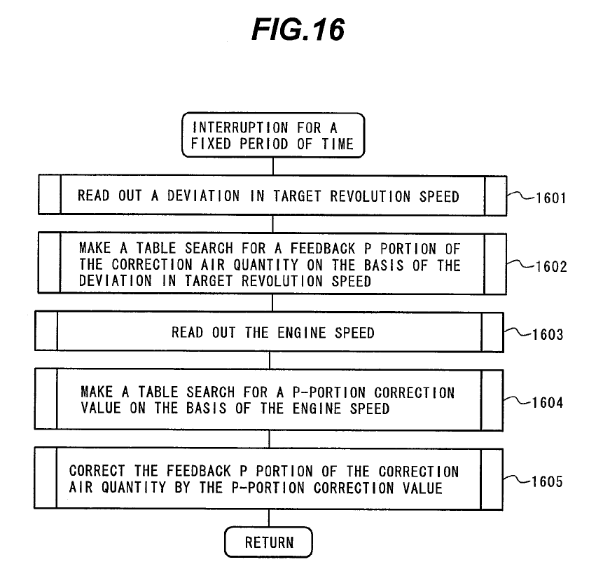

FIG. 16 is a flowchart illustrating an example of how to calculate the feedback P portion shown in FIGS. 6, 7. In Step 1601, a deviation in target revolution speed is read out. In Step 1602, on the basis of the deviation in target revolution speed, a table search is made for a feedback P portion of the correction air quantity. In Step 1603, the engine speed is read out. In Step 1604, on the basis of the engine speed, a table search is made for a P-portion correction value. In Step 1605, the feedback P portion is corrected by the P-portion correction value.

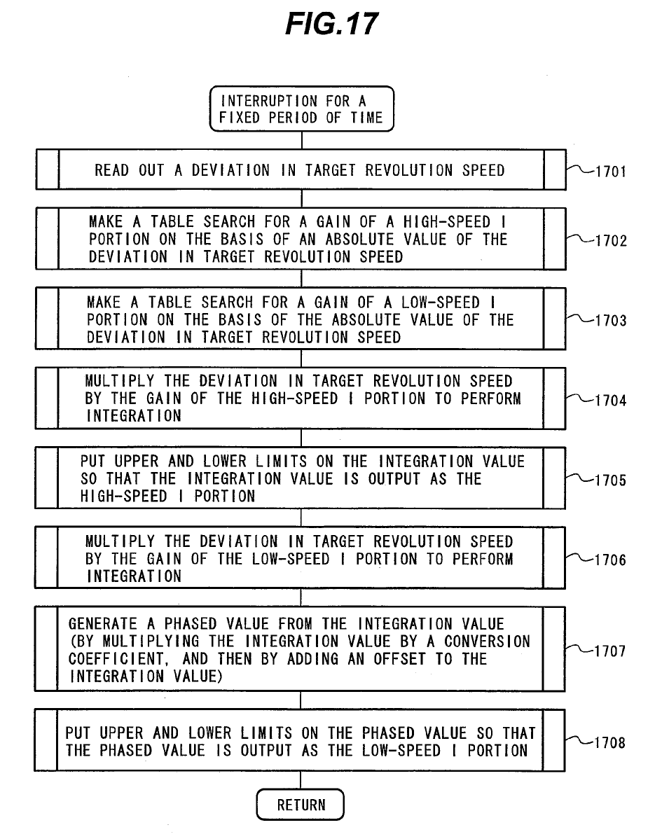

FIG. 17 is a flowchart illustrating an example of how to calculate the feedback I portion shown in FIG. 7. In Step 1701, a deviation in target revolution speed is read out. In Step 1702, on the basis of an absolute value of the deviation in target revolution speed, a table search is made for a gain of a high-speed I portion. In Step 1703, on the basis of the absolute value of the deviation in target revolution speed, a table search is made for a gain of a low-speed I portion. In Step 1704, the deviation in target revolution speed is multiplied by the gain of the high-speed I portion to perform integration. In Step 1705, upper and lower limits are put on the integration value so that the integration value is output as a final value of the high-speed I portion. In Step 1706, the deviation in target revolution speed is multiplied by the gain of the low-speed I portion to perform integration. In Step 1707, the integration value is multiplied by a conversion coefficient, and an offset is then added to the integration value, so that a phased value is generated. In Step 1708, upper and lower limits are put on the phased value so that the phased value is output as a final value of the low-speed I portion.

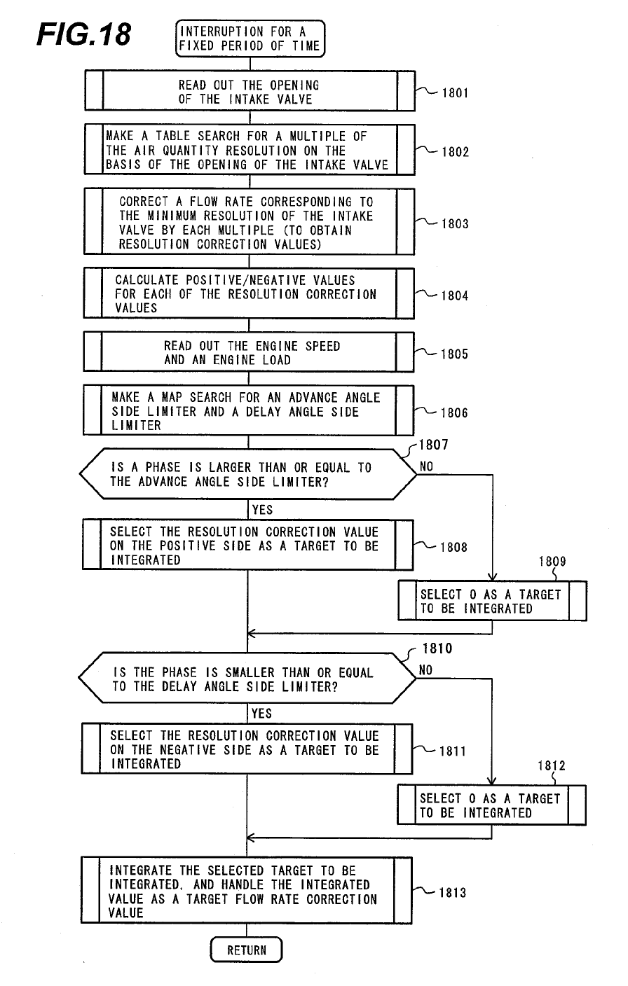

FIG. 18 is a flowchart illustrating an example of target flow rate correction processing included in the phase control amount arithmetic operation shown in FIGS. 6, 7. In Step 1801, the opening angle of the intake valve is read out. In Step 1802, on the basis of the opening angle of the intake valve, a table search is made for multiples of the air quantity resolution. In Step 1803, a flow rate corresponding to the minimum resolution of the intake valve, which is defined as a constant, is multiplied by each of the multiples to make a correction. In Step 1804, positive/negative values are prepared for each of the corrected values obtained by the multiplication by the multiples. In Step 1805, the engine speed and an engine load are read out. In Step 1806, on the basis of the engine speed and the engine load, a map search is made for an advance angle side limiter and a retard angle side limiter. In Step 1807, a judgment is made as to whether or not a phase is larger than or equal to the advance angle side limiter. If it is judged that the phase is larger than or equal to the advance angle side limiter, the corrected flow rate corresponding to the minimum resolution on the positive side is selected in Step 1808. If it is judged in Step 1807 that the phase is smaller than the advance angle side limiter, 0 is selected as a target to be integrated (no integration) in Step 1809. In Step 1810, a judgment is made as to whether or not a phase is smaller than or equal to the retard angle side limiter. If it is judged that the phase is smaller than or equal to the retard angle side limiter, the corrected flow rate corresponding to the minimum resolution on the negative side is selected in Step 1811. If it is judged in Step 1810 that the phase is larger than the retard angle side limiter, 0 is selected as the target to be integrated (no integration) in Step 1812. In Step 1813, the selected target to be integrated is integrated; and the integrated value is handled as a target flow rate correction value.

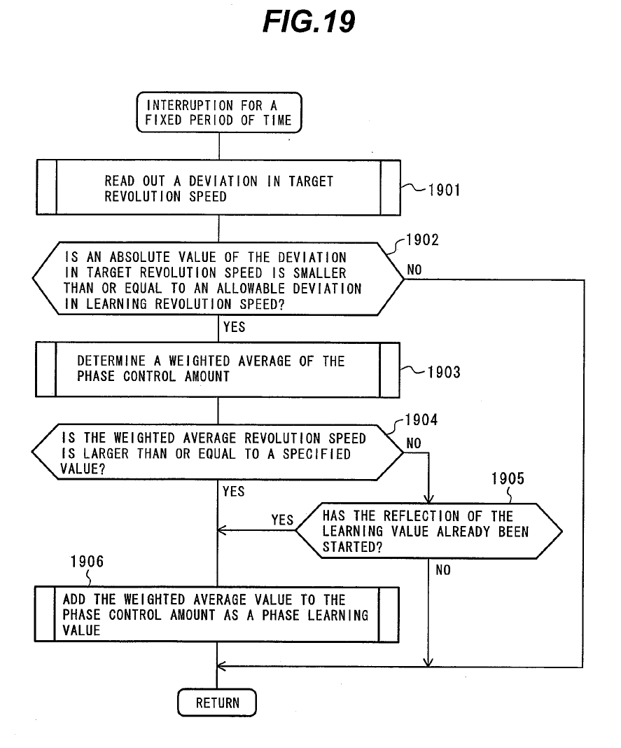

FIG. 19 is a flowchart illustrating an example of how to calculate a phase learning value in the phase control amount arithmetic operation shown in FIGS. 6, 7. In Step 1901, a deviation in target revolution speed is read out. In Step 1902, a judgment is made as to whether or not an absolute value of the deviation in target revolution speed is smaller than or equal to an allowable deviation in learning revolution speed. If it is judged that the absolute value is smaller than or equal to the allowable deviation in learning revolution speed, a weighted average of the phase control amount is determined in Step 1903. In Step 1904, a judgment is made as to whether or not the weighted average revolution speed is larger than or equal to a specified value; in Step 1905, a judgment is made as to whether or not the reflection of the learning value has already been started. If it is judged to be “yes” in the step 1904 or 1905, the weighted average value is added to the phase control amount as a phase learning value in Step 1906.

1. An engine fuel control system comprising:
means for acquiring the revolution speed of an engine;
means for controlling the opening angle of an intake valve;
means for controlling a phase of the intake valve;
means for detecting an idle state of the engine;
means for setting the target revolution speed at the time of idling;
means for acquiring a plurality of control variables that enable the engine to operate at the target revolution speed when the idle state is detected;
means for assigning a control variable whose amount of change is large to the control of the opening angle of the intake valve, said control variable being selected from among the plurality of control variables; and
means for assigning a control variable whose amount of change is small to the control of a phase of the intake valve, said control variable being selected from among the plurality of control variables.

2. The engine fuel control system according to claim 1, wherein:
said means for assigning a variable whose amount of change is large includes:
means for acquiring the minimum resolution of the opening angle of the intake valve for the amount of intake air;
means for acquiring an air flow rate corresponding to each integral multiple of the minimum resolution; and
means for controlling the opening angle of the intake valve on an air flow rate basis corresponding to each integral multiple.

3. The engine fuel control system according to claim 1, wherein:
said means for acquiring a plurality of control variables includes:
means for acquiring a deviation of the revolution speed of the engine from the target revolution speed;
means for acquiring a feedback P portion by multiplying the deviation by a first specified value; and
means for acquiring a feedback I portion by integrating a value obtained by multiplying the deviation by a second specified value.

4. The engine fuel control system according to claim 1, wherein:
said means for acquiring the second specified value includes means for acquiring a plurality of second values that differ from one another.

5. The engine fuel control system according to claim 1, wherein:
said means for acquiring the feedback I portion includes means for acquiring a plurality of I portions from the plurality of second values respectively.

6. The engine fuel control system according to claim 1, wherein:
said means for assigning a control variable whose amount of change is small to the control of a phase of the intake valve includes:
means for acquiring a plurality of I portions from the plurality of second values respectively; and
means for assigning at least one I portion selected from among the I portions.
